(19) United States
(12) Patent Application Publication
(10) Pub. No.: US 2025/0229839 A1
(43) Pub. Date: Jul. 17, 2025

(54) VEHICLE FRONT STRUCTURE

(71) Applicant: TOYOTA JIDOSHA KABUSHIKI KAISHA, Toyota-shi (JP)

(72) Inventor: Ryosuke FUKUI, Aichi-gun (JP)

(73) Assignee: TOYOTA JIDOSHA KABUSHIKI KAISHA, Toyota-shi (JP)

(21) Appl. No.: 18/991,747

(22) Filed: Dec. 23, 2024

(30) Foreign Application Priority Data
Jan. 12, 2024 (JP) 2024-003568

(51) Int. Cl. B62D 25/08; B62D 21/15; B62D 25/14; B62D 25/16

(52) U.S. Cl. CPC B62D 25/088; B62D 21/152; B62D 25/14; B62D 25/16

(57) ABSTRACT

A vehicle front structure includes: a die-cast frame body including a dash portion being provided in a front part of a vehicle and separating inside of a vehicle cabin from outside of the vehicle cabin, and a pair of right and left suspension support portions being disposed closer to a front of the vehicle than the dash portion and each supporting a suspension; a first brace connecting the right and left suspension support portions in a vehicle width direction; and a second brace extending in the vehicle width direction, an outer end in the vehicle width direction of the second brace being fixed to an outer edge portion in the vehicle width direction of the frame body at a position closer to the front of the vehicle than the first brace, and an inner end in the vehicle width direction of the second brace being connected to the first brace.

### CROSS-REFERENCE TO RELATED APPLICATION

This application claims priority to Japanese Patent Application No. 2024-003568 filed on Jan. 12, 2024, incorporated herein by reference in its entirety.

### BACKGROUND

### 1. Technical Field

The present disclosure relates to vehicle front structures.

### 2. Description of Related Art

Japanese Unexamined Patent Application Publication No. 2012-166743 (JP 2012-166743 A) discloses a vehicle body front structure including protruding members. The protruding members are provided on outer walls of front side members such that the protruding members protrude outward of the outer walls in a vehicle width direction, and such that rear ends of the protruding members are located closer to the rear of a vehicle body than a front end in a vehicle body front-rear direction of a power unit disposed inward of the front side members in the vehicle width direction, as viewed in plan.

### SUMMARY

In a vehicle front structure in which a plurality of frame members of a front part of a vehicle is manufactured by die casting, it is preferable to improve collision safety performance against a small overlap collision.

An object of the present disclosure is to provide a vehicle front structure having improved collision safety performance against a small overlap collision.

A vehicle front structure of claim 1 includes:
a die-cast frame body including a dash portion and a pair of right and left suspension support portions, the dash portion being provided in a front part of a vehicle and separating inside of a vehicle cabin from outside of the vehicle cabin, and the right and left suspension support portions being disposed closer to a front of the vehicle than the dash portion and each supporting a suspension;
a first brace connecting the right and left suspension support portions in a vehicle width direction; and
a second brace extending in the vehicle width direction, an outer end in the vehicle width direction of the second brace being fixed to an outer edge portion in the vehicle width direction of the frame body at a position closer to the front of the vehicle than the first brace, and an inner end in the vehicle width direction of the second brace being connected to the first brace.

The vehicle front structure of claim 1 includes the second brace whose outer end in the vehicle width direction is fixed to the outer edge portion in the vehicle width direction of the frame body at a position closer to the front of the vehicle than the first brace, and whose inner end in the vehicle width direction is connected to the first brace. With this configuration, an impact load applied to the frame body at the time of a small overlap collision (when an object such as a barrier hits the front of the vehicle with a small overlap in the vehicle width direction) is transmitted to the first brace via the second brace. This increases a lateral force (force toward the side of the vehicle opposite to the impacted side in the vehicle width direction) that is applied to the vehicle at the time of the small overlap collision, so that the object passes by the side of the vehicle. As a result, it is possible to avoid a large impact being applied to the vehicle at the time of a small overlap collision and to improve the collision safety performance against a small overlap collision.

According to a vehicle front structure of claim 2,
in the vehicle front structure of claim 1,
the second brace may be tilted toward the front of the vehicle as the second brace gets closer to an outer side in the vehicle width direction of the vehicle, as viewed in plan.

In the vehicle front structure of claim 2, the second brace is tilted toward the front of the vehicle as the second brace gets closer to the outer side in the vehicle width direction of the vehicle, as viewed in plan. The second brace is thus disposed so as to be tilted inward in the vehicle width direction as the second brace gets closer to a rear of the vehicle, as viewed in plan. Therefore, part of the impact load applied from the front of the vehicle to the frame body at the time of a small overlap collision is transmitted inward in the vehicle width direction by the second brace. This can increase a lateral force that is applied to the vehicle at the time of the small overlap collision.

According to a vehicle front structure of claim 3,
the vehicle front structure of claim 1 or 2 may further include
a third brace fixed to the frame body at a position closer to the front of the vehicle than the second brace, and tilted inward in the vehicle width direction as the third brace gets closer to the front of the vehicle, as viewed in plan.

The vehicle front structure of claim 3 further includes the third brace fixed to the frame body at a position closer to the front of the vehicle than the second brace, and tilted inward in the vehicle width direction as the third brace gets closer to the front of the vehicle, as viewed in plan. The portion of the frame body that is located closer to the front of the vehicle than the second brace is thus reinforced. Therefore, when an object hits the frame body at a position closer to the front of the vehicle than the second brace at the time of a small overlap collision, an impact load applied to the frame body is transmitted to the second brace via the third brace. This can effectively increase a lateral force that is applied to the vehicle at the time of the small overlap collision.

According to a vehicle front structure of claim 4,
in the vehicle front structure of claim 3,
an outer end in the vehicle width direction of the third brace may be fixed to the frame body at the same position as the outer end in the vehicle width direction of the second brace.

In the vehicle front structure of claim 4, the outer end in the vehicle width direction of the third brace is fixed to the frame body at the same position as the outer end in the vehicle width direction of the second brace. The third brace and the second brace thus form a generally L-shape as viewed in plan. Therefore, when an object hits the frame body at a position closer to the front of the vehicle than the second brace at the time of a small overlap collision, an impact load is first received by the third brace and then transmitted to the second brace. This can more effectively increase a lateral force that is applied to the vehicle at the time of the small overlap collision.

According to a vehicle front structure of claim 5,
in the vehicle front structure of any one of claims 1 to 4,
the outer edge portion in the vehicle width direction of the frame body may be tilted inward in the vehicle width direction as the outer edge portion gets closer to the front of the vehicle, as viewed in plan.

In the vehicle front structure of claim 5, the outer edge portion in the vehicle width direction of the frame body is tilted inward in the vehicle width direction as the outer edge portion gets closer to the front of the vehicle, as viewed in plan. With this configuration, an impact load is applied to the frame body in an inward direction in the vehicle width direction at the time of a small overlap collision. This can increase a lateral force that is applied to the vehicle at the time of the small overlap collision.

As described above, with the vehicle front structure of the present disclosure, it is possible to improve the collision safety performance against a small overlap collision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a vehicle front structure according to an embodiment;

FIG. 2 is a plan view illustrating a vehicle front structure according to the embodiment;

FIG. 3 is an explanatory view for explaining an operation of the vehicle front structure according to the embodiment at the time of a small overlap collision; and

FIG. 4 is a plan view illustrating a vehicle front structure according to another embodiment.

### DETAILED DESCRIPTION OF EMBODIMENTS

Hereinafter, a vehicle front structure according to an embodiment will be described with reference to the drawings. In the drawings, an arrow UP indicates an upper side in the up-down direction of the vehicle, an arrow FR indicates a front side in the front-rear direction of the vehicle, and an arrow LH indicates a left side in the widthwise direction (left-right direction) of the vehicle.

### Configuration of Vehicle Front Structure 5

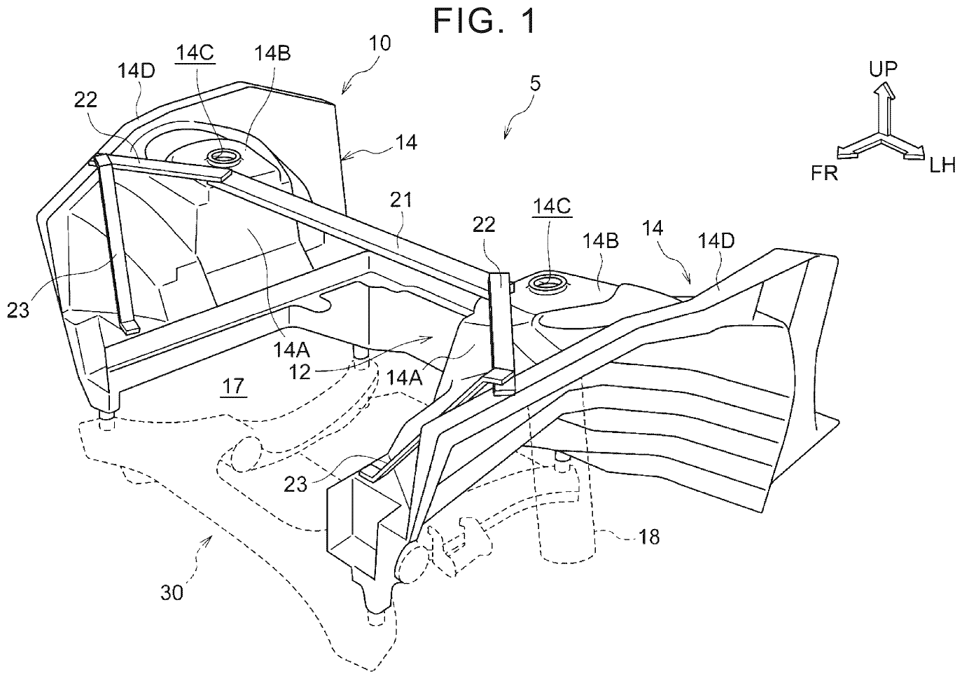

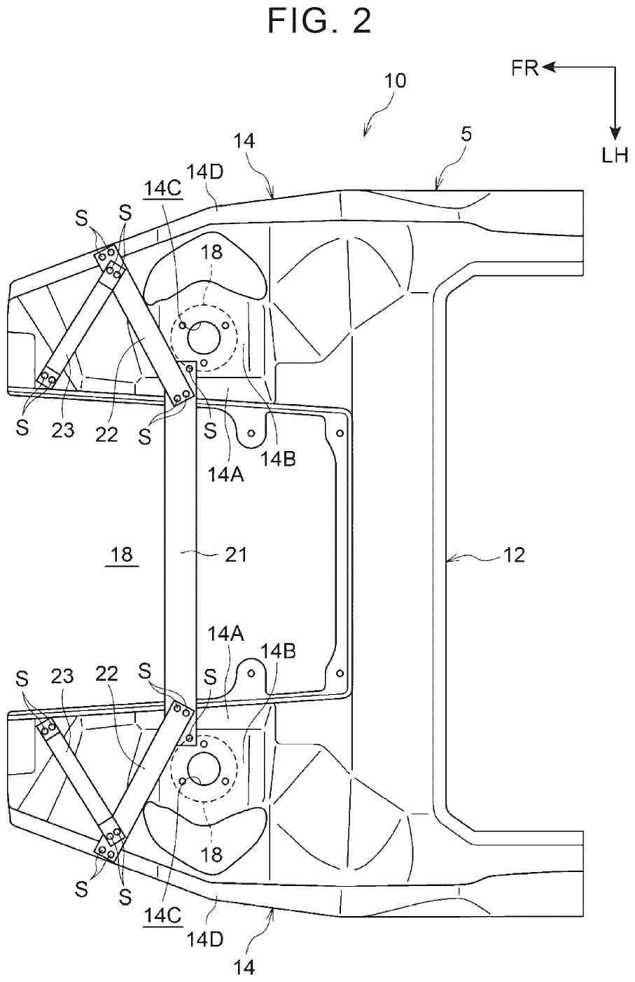

As shown in FIGS. 1 and 2, the vehicle front structure 5 includes a frame body 10, a first brace 21, a second brace 22, and a third brace 23.

### Frame Body 10

The frame body 10 is made of die casting and includes a dash portion 12 and a suspension support portion 14. In other words, the dash portion 12 and the suspension support portion 14 are integrally manufactured by die casting.

### Dash Portion 12

The dash portion 12 is provided at a front portion of the vehicle and separates the inside of the vehicle cabin from the outside of the vehicle cabin. The dash portion 12 is formed in a plate shape extending in the vehicle width direction with the substantially vehicle front-rear direction being a plate thickness direction. The dash portion 12 is a rear wall of the front compartment 17, which is a space in which components such as a prime mover are arranged.

### Suspension Support Portion 14

The suspension support portion 14 is formed in a plate shape extending forward of the vehicle from both end portions of the dash portion 12 in the vehicle width direction. The suspension support portion 14 is provided on a pair of right and left sides on the vehicle front side of the dash portion 12, and supports the suspension 18 (see FIG. 1).

The suspension support portion 14 includes a body portion 14A, a suspension attachment portion 14B, and a flange portion 14D.

The body portion 14A is formed in a curved shape protruding inward in the vehicle width direction so as to accommodate the suspension 18 outward in the vehicle width direction of the body portion 14A. The vehicle front end and the vehicle rear end of the body portion 14A are attached to a suspension member 30 provided below the vehicle on the body portion 14A.

The suspension attachment portion 14B is provided in the vicinity of the center of the body portion 14A in the vehicle widthwise direction and in the vicinity of the center of the body portion 14A in the vehicle longitudinal direction. The suspension attachment portion 14B is formed in a plate shape in which the vehicle-vertical direction is a plate-thickness direction. A mounting opening 14C to which an upper mount (not shown) of the suspension 18 is mounted is formed at the center of the suspension attachment portion 14B in the vehicle front-rear direction, as viewed in plan.

The flange portion 14D is provided outward of the body portion 14A in the vehicle width direction. The flange portion 14D is formed in a plate shape in which the vehicle-vertical direction is a plate-thickness direction. As shown in FIG. 2, the flange portion 14D extends in the vehicle front-rear direction at a position closer to the rear of the vehicle than the mounting opening 14C, as viewed in plan. Further, as shown in FIG. 2, part of the flange portion 14D that is located closer to the front of the vehicle than the mounting opening 14C is tilted inward in the vehicle width direction as it gets closer to the front of the vehicle, as viewed in plan. In other words, part of the outer edge portion in the vehicle width direction of the frame body 10 that is located closer to the rear of the vehicle than the suspension 18 extends in the vehicle front-rear direction, as viewed in plan. Part of the outer edge portion in the vehicle width direction of the frame body 10 that is located closer to the front of the vehicle than the suspension 18 is tilted inward in the vehicle width direction as it gets closer to the front of the vehicle, as viewed in plan.

### First Brace 21

As shown in FIGS. 1 and 2, the first brace 21 is provided so as to span between a pair of right and left suspension attachment portions 14B. In other words, the first brace 21 connects the pair of right and left suspension support portions 14 in the vehicle width direction. The first brace 21 is disposed slightly ahead of the vehicle from the center of the mounting opening 14C.

The first brace 21 is formed of, for example, a steel pipe having a rectangular cross section. The first brace 21 is formed to extend in the vehicle width direction. Both ends in the vehicle width direction of the first brace 21 are attached to the suspension attachment portion 14B by, for example, bolts S. The first brace may connect, in the vehicle width direction, the side walls extending downward in the up-down direction of the vehicle from the inner end in the vehicle width direction of the suspension attachment portion 14B.

### Second Brace 22

The second brace 22 is provided so as to span between the suspension attachment portion 14B and the flange portion 14D. The second brace 22 is disposed in front of the vehicle from the center of the mounting opening 14C.

The second brace 22 is formed of, for example, a steel pipe having a rectangular cross section. The second brace 22 is tilted toward the front of the vehicle as it gets closer to the outer side in the vehicle width direction, as viewed in plan. In the second brace 22, an outer end in the vehicle width direction is fixed to the flange portion 14D at a position closer to the front of the vehicle than the first brace 21 by, for example, a bolt S. The inner end in the vehicle width direction of the second brace 22 is attached to the suspension attachment portion 14B via the outer end in vehicle width direction of the first brace 21 by, for example, a bolt S. The outer end in the vehicle width direction of the first brace 21 and the inner end in the vehicle width direction of the second brace 22 may be fastened together by a common bolt S.

### Third Brace 23

The third brace 23 is provided so as to span between the flange portion 14D and the lower portion of the body portion 14A. The third brace 23 is disposed in front of the vehicle from the center of the mounting opening 14C. The third brace 23 is disposed in front of the vehicle from the first brace 21 and the second brace 22.

The third brace 23 is formed of, for example, a steel pipe having a rectangular cross section. The third brace 23 is tilted inward in the vehicle width direction as it gets closer to the front of the vehicle, as viewed in plan. The third brace 23 is tilted downward in the vehicle up-down direction as it gets closer to the front of the vehicle, as viewed from the side. The outer end in the vehicle width direction of the third brace 23 is fixed to the suspension support portion 14 via the second brace 22 at substantially the same position as the outer end in the vehicle width direction of the second brace 22, for example, by a bolt S. The inner end in the vehicle width direction of the third brace 23 is fixed to the lower part of the body portion 14A by, for example, a bolt S. The outer end in the vehicle width direction of the third brace 23 and the outer end in the vehicle width direction of the second brace 22 may be fastened together by a common bolt S.

### Operation of Vehicle Front Structure 5 in the Event of Small Overlap Collision

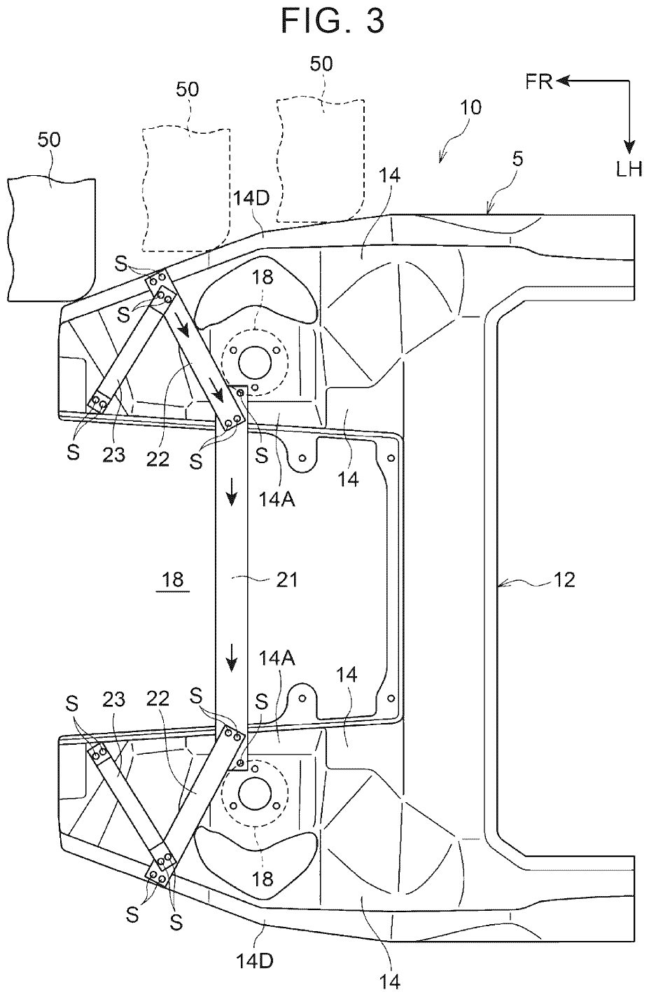

FIG. 3 shows a small overlap collision in which an object 50 such as a barrier hits the front of the vehicle with a small overlap in the vehicle width direction. At the time of a small overlap collision, the object 50 hits the flange portion 14D that is tilted inward in the vehicle width direction as it gets closer to the front of the vehicle as viewed in plan on the side closer to the front of the vehicle than the suspension support portion 14. When the object 50 hits the flange portion 14D, the impact load from the object 50 is transmitted from the flange portion 14D to the second brace 22. At this time, the impact load from the object 50 is also transmitted to the third brace 23.

The impact load transmitted to the second brace 22 is transmitted from the second brace 22 to the first brace 21. The impact load transmitted to the third brace 23 is transmitted to the first brace 21 via the second brace 22. As a result, a lateral force is applied to the vehicle in the vehicle width direction toward the side opposite to the impact side. Then, the vehicle moves in the vehicle width direction by the applied lateral force, so that the object 50 passes by the side of the vehicle.

### Operations

The vehicle front structure 5 according to the embodiment includes a die-cast frame body 10 including a dash portion 12 and a pair of right and left suspension support portions 14, a first brace 21, and a second brace 22 (see FIG. 1). The dash portion 12 is provided in the front part of the vehicle and separates the inside of the vehicle cabin from the outside of the vehicle cabin. The pair of right and left suspension support portions 14 is disposed on the vehicle front side of the dash portion 12 and supports the suspension 18. The first brace 21 connects the pair of right and left suspension support portions 14 in the vehicle width direction. The second brace 22 extends in the vehicle width direction. The outer end in the vehicle width direction of the second brace 22 is fixed to the outer edge portion in the vehicle width direction of the frame body 10 at a position closer to the front of the vehicle than the first brace 21, and the inner end in the vehicle width direction of the second brace 22 is connected to the first brace 21.

A second brace 22 is included whose outer end in the vehicle width direction is fixed to the outer edge portion in the vehicle width direction of the frame body 10 at a position closer to the front of the vehicle than the first brace 21, and whose inner end in the vehicle width direction connected to the first brace 21. Accordingly, the impact load applied to the frame body 10 at the time of a small overlap collision is transmitted to the first brace 21 via the second brace 22. This increases a lateral force that is applied to the vehicle at the time of the small overlap collision, so that the object 50 passes by the side of the vehicle. As a result, it is possible to avoid a large impact being applied to the vehicle at the time of a small overlap collision and to improve the collision safety performance against a small overlap collision.

In the vehicle front structure 5 according to the embodiment, the second brace 22 is tilted toward the front of the vehicle as it gets closer to the outer side of the vehicle, as viewed in plan (see FIG. 2).

The second brace 22 is tilted toward the front of the vehicle as it gets closer to the outer side of the vehicle, as viewed in plan. The second brace 22 is thus disposed so as to be tilted inward in the vehicle width direction as it gets closer to the rear of the vehicle, as viewed in plan. Therefore, at the time of the small overlap collision, part of the impact load applied from the front of the vehicle to the frame body 10 is transmitted inward in the vehicle width direction by the second brace 22. This can increase a lateral force that is applied to the vehicle at the time of the small overlap collision.

The vehicle front structure 5 of the embodiment further includes a third brace 23 fixed to the frame body 10 at a position closer to the front of the vehicle than the second brace 22, and tilted inward in the vehicle width direction as it gets closer to the front of the vehicle, as viewed in plan (see FIG. 2).

A third brace 23 is further included that is fixed to the frame body 10 at a position closer to the front of the vehicle than the second brace 22, and that is tilted inward in the vehicle width direction as it gets closer to the front of the vehicle, as viewed in plan. As a result, the vehicle front side of the second brace 22 of the frame body 10 is reinforced. Therefore, when the object 50 hits the frame body 10 at a position closer to the front of the vehicle than the second brace 22 at the time of a small overlap collision, the impact load applied to the frame body 10 is transmitted to the second brace 22 via the third brace 23. This can effectively increase a lateral force that is applied to the vehicle at the time of the small overlap collision.

In the vehicle front structure 5 according to the embodiment, the outer end in the vehicle width direction of the third brace 23 is fixed to the frame body 10 at the same position as the outer end in the vehicle width direction of the second brace 22 (see FIG. 2).

The outer end in the vehicle width direction of the third brace 23 is fixed to the frame body 10 at the same position as the outer end in the vehicle width direction of the second brace 22, so that the third brace 23 and the second brace 22 form an L-shape as viewed in plan. Therefore, when the object 50 hits the frame body 10 at a position closer to the front of the vehicle than the second brace 22 at the time of a small overlap collision, an impact load is first received by the third brace 23 and then transmitted to the second brace 22. This can more effectively increase a lateral force that is applied to the vehicle at the time of the small overlap collision.

In the vehicle front structure 5 according to the embodiment, the outer edge portion in the vehicle width direction of the frame body 10 is tilted inward in the vehicle width direction as it gets closer to the front of the vehicle, as viewed in plan (see FIG. 2).

The outer edge portion in the vehicle width direction of the frame body 10 is tilted inward in the vehicle width direction as it gets closer to the front of the vehicle as viewed in plan, so that the impact load is applied to the frame body 10 in an inward direction in the vehicle width direction at the time of a small overlap collision. This can increase a lateral force that is applied to the vehicle at the time of the small overlap collision.

The vehicle front structure according to the embodiment has been described above based on the embodiment. However, the specific configuration is not limited to this embodiment, and changes in design and the like are allowed without departing from the gist of the disclosure according to each claim of the claims.

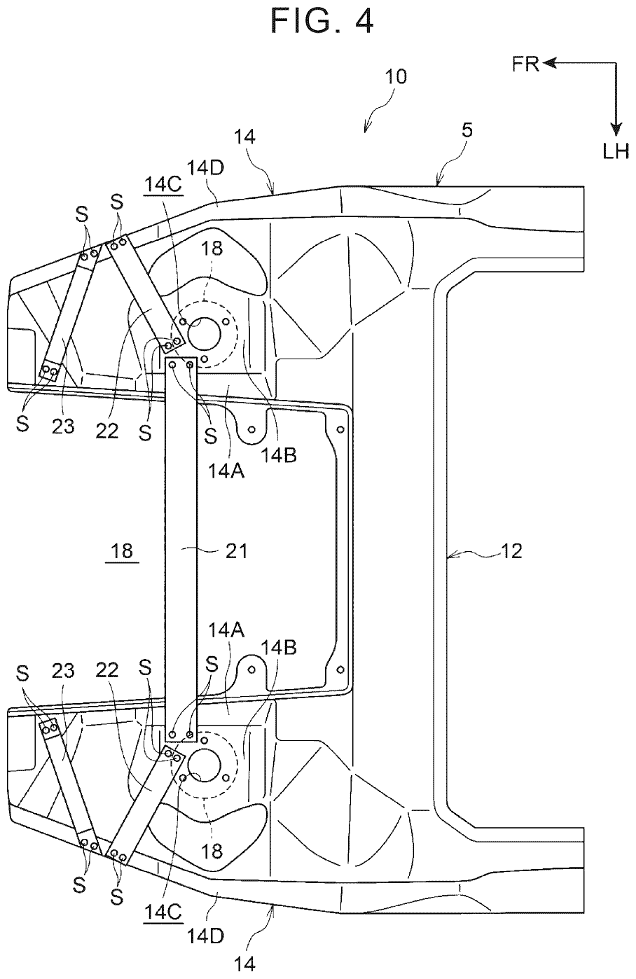

In the embodiment, the inner end in the vehicle width direction of the second brace 22 is attached to the suspension attachment portion 14B via the outer end in the vehicle width direction of the first brace 21. In the embodiment, the outer end in the vehicle width direction of the third brace 23 is fixed to the suspension support portion 14 via the second brace 22. In the embodiment, such an example is shown. However, as shown in FIG. 4, the second brace 22 may be attached to the suspension attachment portion 14B such that the inner end in the vehicle width direction of the second brace 22 is connected to the first brace 21 at a position near the outer end in the vehicle width direction of the first brace 21. The outer end in the vehicle width direction of the third brace 23 may be attached to the flange portion 14D at a position closer to the front of the vehicle than the outer end in the vehicle width direction of the second brace 22.

The embodiment illustrates an example in which the second brace 22 is tilted toward the front of the vehicle as it gets closer to the outer side in the vehicle width direction, as viewed in plan. However, the second brace may be tilted toward the rear of the vehicle as it gets closer to the outer side in the vehicle width direction or may extend in the vehicle width direction, as viewed in plan.

In the embodiment, the first brace 21, the second brace 22, and the third brace 23 are each formed of a steel pipe having a rectangular cross section. However, the first brace, the second brace, and the third brace are not limited to this embodiment, and may be, for example, plate-shaped brackets.

In the embodiment, the first brace 21, the second brace 22, and the third brace 23 are attached to the frame body 10 by the bolt S. However, the first brace, the second brace, and the third brace are not limited to this embodiment, and may be attached to the frame body by welding, for example.

In the embodiment, the vehicle front structure 5 includes the first brace 21, the second brace 22, and the third brace 23. However, the vehicle front structure may not include the third brace 23.

In the embodiment, the first brace 21, the second brace 22, and the third brace 23 are configured separately. However, at least two of the first brace, the second brace, and the third brace may be integrally formed.

In the embodiment, in the first brace 21, the first brace 21 is provided so as to span between the pair of right and left suspension attachment portions 14B. However, the first brace may be provided on the pair of right and left suspension support portions 14.

In the embodiment, the outer edge portion in the vehicle width direction of the frame body 10 is referred to as a flange portion 14D. However, the outer edge portion in the vehicle width direction of the frame body may be an outer edge portion in the vehicle width direction of the body portion 14A.

In the embodiment, the frame body 10 includes the dash portion 12 and the suspension support portion 14. However, the frame body may include other components that make up the vehicle front structure.

What is claimed is:

1. A vehicle front structure comprising:
a die-cast frame body including a dash portion and a pair of right and left suspension support portions, the dash portion being provided in a front part of a vehicle and separating inside of a vehicle cabin from outside of the vehicle cabin, and the right and left suspension support portions being disposed closer to a front of the vehicle than the dash portion and each supporting a suspension;
a first brace connecting the right and left suspension support portions in a vehicle width direction; and
a second brace extending in the vehicle width direction, an outer end in the vehicle width direction of the second brace being fixed to an outer edge portion in the vehicle width direction of the frame body at a position closer to the front of the vehicle than the first brace, and an inner end in the vehicle width direction of the second brace being connected to the first brace.

2. The vehicle front structure according to claim 1, wherein the second brace is tilted toward the front of the vehicle as the second brace gets closer to an outer side in the vehicle width direction of the vehicle, as viewed in plan.

3. The vehicle front structure according to claim 1, further comprising a third brace fixed to the frame body at a position closer to the front of the vehicle than the second brace, and tilted inward in the vehicle width direction as the third brace gets closer to the front of the vehicle, as viewed in plan.

4. The vehicle front structure according to claim 3, wherein an outer end in the vehicle width direction of the third brace is fixed to the frame body at the same position as the outer end in the vehicle width direction of the second brace.

5. The vehicle front structure according to claim 1, wherein the outer edge portion in the vehicle width direction of the frame body is tilted inward in the vehicle width direction as the outer edge portion gets closer to the front of the vehicle, as viewed in plan.
